(19) United States
(12) Patent Application Publication
(10) Pub. No.: US 2025/0294618 A1
(43) Pub. Date: Sep. 18, 2025

(54) NETWORK INTEGRATION OF NETWORK-CONTROLLED REPEATERS

(71) Applicant: QUALCOMM Incorporated, San Diego, CA (US)

(72) Inventors: Jianhua LIU, Beijing (CN); Karl Georg HAMPEL, Jersey City, NJ (US); Naeem AKL, Bridgewater, NJ (US); Navid ABEDINI, Basking Ridge, NJ (US); Jianghong LUO, Skillman, NJ (US)

(21) Appl. No.: 18/862,931

(22) PCT Filed: May 6, 2022
(86) PCT No.: PCT/CN2022/091099

§ 371 Date: Nov. 4, 2024

(51) Int. Cl. H04W 74/0833; H04L 5/00

(52) U.S. Cl. CPC H04W 74/0833; H04L 5/0055

(57) ABSTRACT

Disclosed are systems and techniques for performing wireless communication. In some aspects, a network-controlled repeater (or component thereof) may transmit a first message to a network entity. The first message includes an identifier associated with the network-controlled repeater for use as part of a multi-step Random Access Channel (RACH) process. The network-controlled repeater (or component thereof) may receive, from the network entity, a second message at least one of identifying or authorizing the network-controlled repeater for the RACH process.

### CROSS-REFERENCE TO RELATED APPLICATIONS

This application for patent is a 371 of international Patent Application PCT/CN2022/091099, filed May 6, 2022, which is hereby incorporated by referenced in its entirety and for all purposes.

### FIELD OF THE DISCLOSURE

Aspects of the present disclosure generally relate to wireless communication. In some implementations, examples are described for network integration of network-controlled repeaters, such as in a Physical (PHY) layer and/or Medium Access Control (MAC) layer only architecture.

### BACKGROUND OF THE DISCLOSURE

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media (referred to as “systems and techniques”) for performing wireless communication. For example, the systems and techniques described herein provide solutions for network integration of network-controlled repeaters, such as in a Physical (PHY) layer and/or Medium Access Control (MAC) layer only architecture. In one illustrative example, the systems and techniques can perform wireless communications in the context of using a repeater that only implements a PHY/MAC layer, and may address the need for identification, authorization, and/or authentication of the repeater and/or user devices communicating with the repeater.

According to at least one example, a method of wireless communications at a network-controlled repeater is provided. The method includes: transmitting, from the network-controlled repeater, a first message to a network entity, the first message including an identifier associated with the network-controlled repeater for use as part of a multi-step Random Access Channel (RACH) process; and receiving, from the network entity, a second message at least one of identifying or authorizing the network-controlled repeater for the RACH process.

In another example, an apparatus for wireless communications is provided that includes at least one memory and at least one processor coupled to the at least one memory. The at least one processor is configured to: output a first message for transmission to a network entity, the first message including an identifier associated with the apparatus for use as part of a multi-step Random Access Channel (RACH) process; and receive, from the network entity, a second message at least one of identifying or authorizing the apparatus for the RACH process.

In another example, a non-transitory computer-readable medium of a network-controlled repeater is provided that has stored thereon instructions that, when executed by one or more processors, cause the one or more processors to: output a first message for transmission to a network entity, the first message including an identifier associated with the network-controlled repeater for use as part of a multi-step Random Access Channel (RACH) process; and receive, from the network entity, a second message at least one of identifying or authorizing the network-controlled repeater for the RACH process.

In another example, an apparatus for wireless communications is provided. The apparatus includes: means for transmitting a first message to a network entity, the first message including an identifier associated with the apparatus for use as part of a multi-step Random Access Channel (RACH) process; and means for receiving, from the network entity, a second message at least one of identifying or authorizing the apparatus for the RACH process.

According to at least one other example, a method of wireless communication at a network-controlled repeater is provided. The method includes: transmitting, from the network-controlled repeater, an authenticator to a network entity via a Medium Access Control (MAC) Control Element (CE) for performing authentication of the network-controlled repeater; and receiving, at the network-controlled repeater, an authentication result from the network entity.

In another example, an apparatus for wireless communications is provided that includes at least one memory and at least one processor coupled to the at least one memory. The at least one processor is configured to: output an authenticator for transmission to a network entity via a Medium Access Control (MAC) Control Element (CE) for performing authentication of the apparatus; and receive an authentication result from the network entity.

In another example, a non-transitory computer-readable medium of a network-controlled repeater is provided that has stored thereon instructions that, when executed by one or more processors, cause the one or more processors to: output an authenticator for transmission to a network entity via a Medium Access Control (MAC) Control Element (CE) for performing authentication of the network-controlled repeater; and receive an authentication result from the network entity.

In another example, an apparatus for wireless communications is provided. The apparatus includes: means for transmitting an authenticator to a network entity via a Medium Access Control (MAC) Control Element (CE) for performing authentication of the apparatus; and means for receiving an authentication result from the network entity.

According to at least one other example, a method of wireless communication at a first network entity is provided. The method includes: transmitting, from the first network entity to a second network entity, a message including at least one of a request for identification and authorization of a network-controlled repeater or a request for authentication of the network-controlled repeater; and receiving, at the first network entity from the second network entity, a response message associated with at least one of the request for identification and authorization of the network-controlled repeater or the request for authentication of the network-controlled repeater.

In another example, an apparatus for wireless communications is provided that includes at least one memory and at least one processor coupled to the at least one memory. The at least one processor is configured to: output a message for transmission to a network entity, the message including at least one of a request for identification and authorization of a network-controlled repeater or a request for authentication of the network-controlled repeater; and receive, from the network entity, a response message associated with at least one of the request for identification and authorization of the network-controlled repeater or the request for authentication of the network-controlled repeater.

In another example, a non-transitory computer-readable medium of a first network entity is provided that has stored thereon instructions that, when executed by one or more processors, cause the one or more processors to: output a message for transmission to a second network entity, the message including at least one of a request for identification and authorization of a network-controlled repeater or a request for authentication of the network-controlled repeater; and receive, from the second network entity, a response message associated with at least one of the request for identification and authorization of the network-controlled repeater or the request for authentication of the network-controlled repeater.

In another example, an apparatus for wireless communications is provided. The apparatus includes: means for transmitting, to a network entity, a message including at least one of a request for identification and authorization of a network-controlled repeater or a request for authentication of the network-controlled repeater; and means for receiving, from the network entity, a response message associated with at least one of the request for identification and authorization of the network-controlled repeater or the request for authentication of the network-controlled repeater.

According to at least one other example, a method of wireless communication at a network entity is provided. The method includes: receiving, from a network-controlled repeater, a first message, the first message including an identifier associated with the network-controlled repeater for use as part of a multi-step Random Access Channel (RACH) process; and transmitting, to the network-controlled repeater, a second message at least one of identifying or authorizing the network-controlled repeater for the RACH process.

In another example, an apparatus for wireless communications is provided that includes at least one memory and at least one processor coupled to the at least one memory. The at least one processor is configured to: receive, from a network-controlled repeater, a first message, the first message including an identifier associated with the network-controlled repeater for use as part of a multi-step Random Access Channel (RACH) process; and output a second message for transmission to the network-controlled repeater, the second message at least one of identifying or authorizing the network-controlled repeater for the RACH process.

In another example, a non-transitory computer-readable medium of a network entity is provided that has stored thereon instructions that, when executed by one or more processors, cause the one or more processors to: receive, from a network-controlled repeater, a first message, the first message including an identifier associated with the network-controlled repeater for use as part of a multi-step Random Access Channel (RACH) process; and output a second message for transmission to the network-controlled repeater, the second message at least one of identifying or authorizing the network-controlled repeater for the RACH process.

In another example, an apparatus for wireless communications is provided. The apparatus includes: means for receiving, from a network-controlled repeater, a first message, the first message including an identifier associated with the network-controlled repeater for use as part of a multi-step Random Access Channel (RACH) process; and means for transmitting, to the network-controlled repeater, a second message at least one of identifying or authorizing the network-controlled repeater for the RACH process.

According to at least one other example, a method of wireless communication at a network entity is provided. The method includes: receiving, from a network-controlled repeater, an authenticator via a Medium Access Control (MAC) Control Element (CE) for performing authentication of the network-controlled repeater; and transmitting an authentication result to the network-controlled repeater.

In another example, an apparatus for wireless communications is provided that includes at least one memory and at least one processor coupled to the at least one memory. The at least one processor is configured to: receive, from a network-controlled repeater, an authenticator via a Medium Access Control (MAC) Control Element (CE) for performing authentication of the network-controlled repeater; and output an authentication result for transmission to the network-controlled repeater.

In another example, a non-transitory computer-readable medium of a first network entity is provided that has stored thereon instructions that, when executed by one or more processors, cause the one or more processors to: receive, from a network-controlled repeater, an authenticator via a Medium Access Control (MAC) Control Element (CE) for performing authentication of the network-controlled repeater; and output an authentication result for transmission to the network-controlled repeater.

In another example, an apparatus for wireless communications is provided. The apparatus includes: means for receiving, from a network-controlled repeater, an authenticator via a Medium Access Control (MAC) Control Element (CE) for performing authentication of the network-controlled repeater; and means for transmitting an authentication result to the network-controlled repeater.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples:

FIG. 3 is a diagram illustrating an example of a disaggregated base station, in accordance with some examples:

FIG. 4 is a block diagram illustrating components of a user equipment, in accordance with some examples:

FIG. 5 illustrates a block diagram illustrating communications among a UE, a network-controlled repeater (NCR), and other network components:

FIGS. 6A-6J illustrate various message flows and data structures:

FIG. 7A is a signaling diagram illustrating communications between a distributed unit and a centralized unit:

FIG. 7B is a signaling diagram illustrating communications between a centralized unit and a central network:

FIG. 8 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks are deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE. This case focuses further no a framework in which the UE communicates with a network-controlled repeater, which its specific structure, that then communicates with a network entity such as a distributed unit, centralized unit which then communicates with the core network.

Coverage is a fundamental aspect of cellular network deployments. Mobile operators rely on different types of network nodes or entities to offer blanket coverage in their deployments. Deployment of regular full-stack cells is one option, but it may not be always possible (e.g., no availability of backhaul) or economically viable.

In some cases, a client device may be outside of the coverage area associated with a wireless communication network. For example, a client device may be located in a geographical area that is outside the range of the nearest base station or in a geographical area with poor signal quality. As a result, new types of network nodes have been considered to increase mobile operators' flexibility for their network deployments. One type of network node is a radio frequency (RF) repeater, which amplifies and forwards any signal that is received by the RF repeater. In such cases, access to a wireless communication network may be possible by using the repeater.

While a RF repeater may present a cost-effective means of extending network coverage, it has its limitations. For example, as noted above, an RF repeater simply does an amplify-and-forward operation without being able to take into account various factors that could improve performance. Such factors may include information on semi-static and/or dynamic downlink/uplink configuration, adaptive transmitter/receiver spatial beamforming, ON-OFF status, etc.

As described in more detail below; processes (also referred to as methods), and computer-readable media (collectively referred to as “systems and techniques”) are described herein for network integration of network-controlled repeaters, such as network-controlled repeaters that use a Physical (PHY) layer and/or Medium Access Control (MAC) layer only architecture. In some illustrative aspects, the systems and techniques can perform wireless communications in the context of using a repeater that implements only a PHY/MAC layer. The systems and techniques may address the need for identification, authorization, and authentication of the repeater and/or user devices communicating with the repeater.

Additional aspects of the present disclosure are described in more detail below.

As used herein, the terms “user equipment” (UE) and “network entity” or “network node” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAE) or drone, helicopter, airship, glider, etc.) and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity or network node can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity,” “network node,” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity/node or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

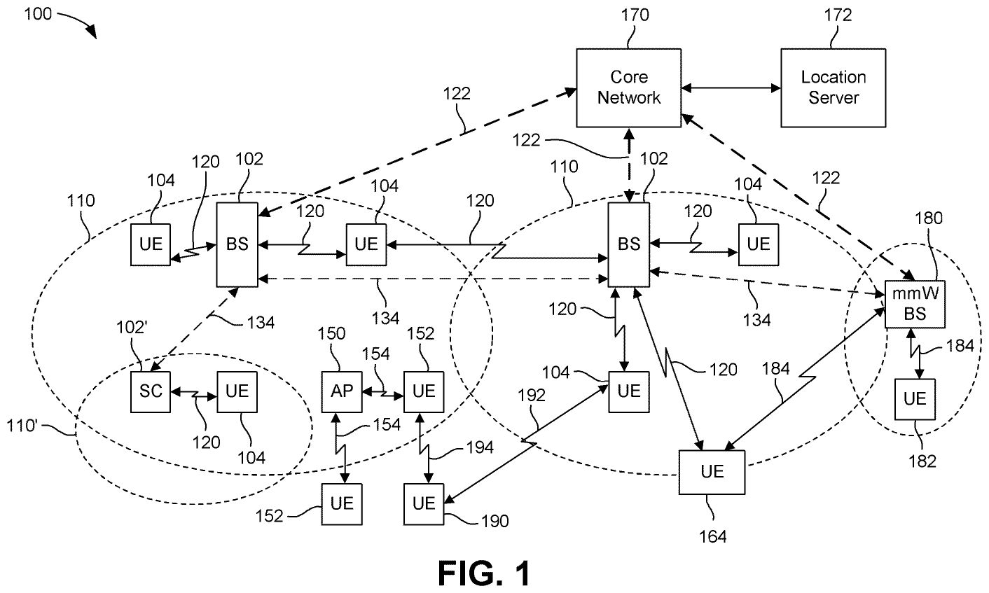

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz. (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHZ and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHZ and 30 GHZ, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell.” “serving cell.” “component carrier,” “carrier frequency.” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHZ) bandwidth per carrier up to a total of Yx MHZ (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHZ aggregated carriers in a multi-carrier system would theoretically lead to a two-fold increase in data rate (i.e., 40 MHZ), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2.” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

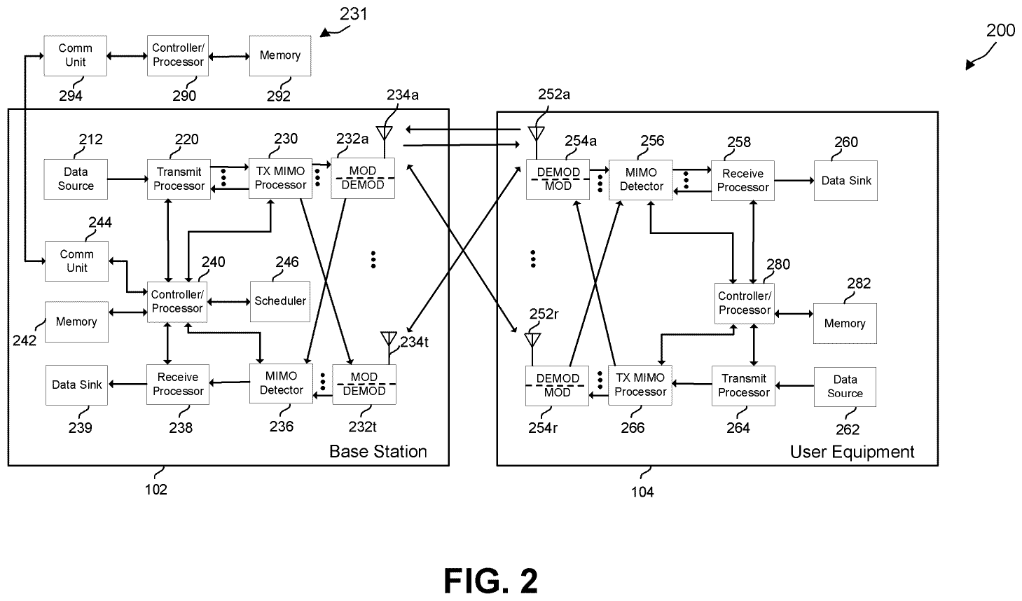

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 2347, respectively. According to certain aspects described in more detail below, the synchronization signals can be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254 through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ. CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234/, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element or entity, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

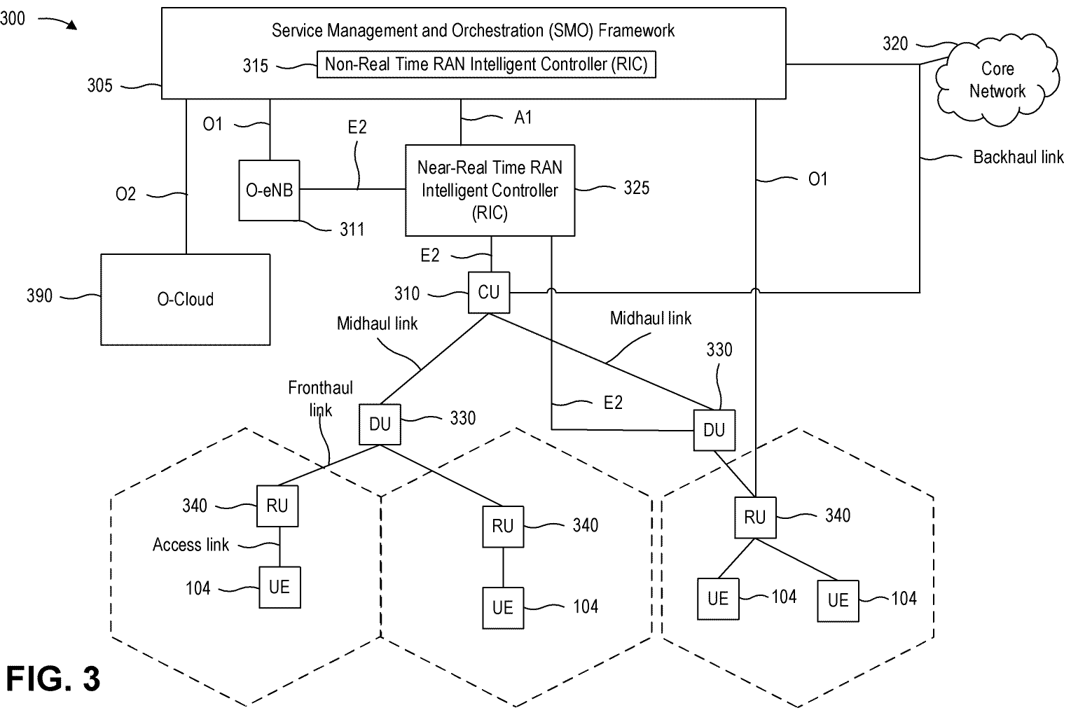

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The F1 interface defines inter-connection of a CU 310 and a DU 330 supplied by different manufacturers. The interface supports control plane and user plane separation. It can separate the Radio Network Layer and Transport Network Layer as well. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

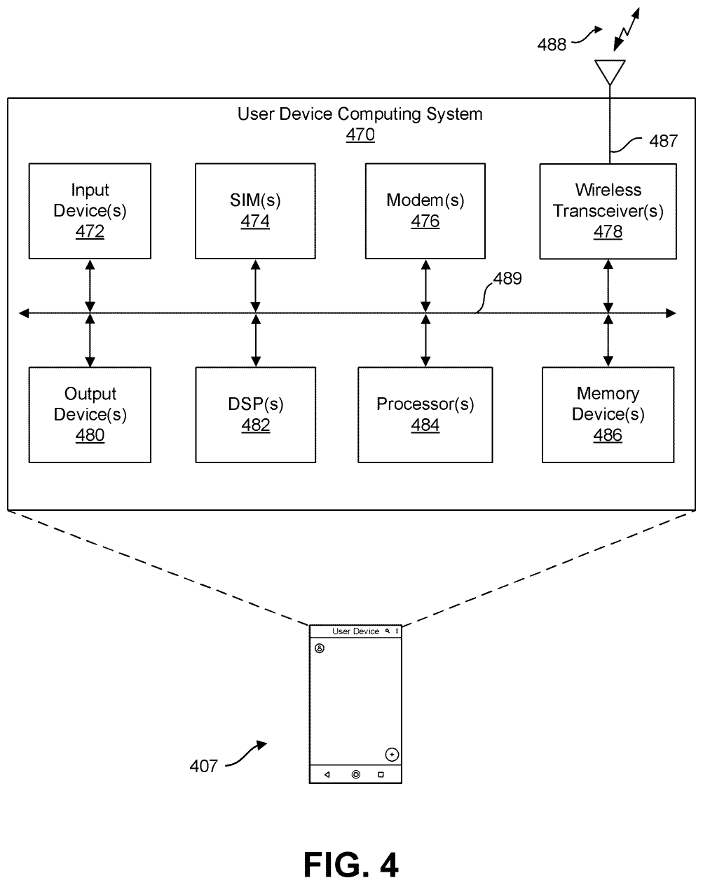

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

As noted previously, systems and techniques are described herein for network integration of network-controlled repeaters, such as network-controlled repeaters that use a Physical (PHY) layer and/or Medium Access Control (MAC) layer only architecture. In some illustrative aspects, the systems and techniques can perform wireless communications in the context of using a repeater that implements only a PHY layer, MAC layer, and/or both the PHY and MAC layers. The systems and techniques may address the need for identification, authorization, and authentication of the network-controlled repeater and/or user devices communicating with the repeater. For instance, repeater identification, authorization, and authentication may be performed over the PHY/MAC layer.

Identification and authorization of a device (e.g., a UE, a network-controlled repeater, etc.) is typically performed in a core network (CN) with the device's subscription check. However, for a network-controlled repeater (NCR), in order to reduce the cost of the NCR, it is desirable to implement as few functions as possible on the NCR. The systems and techniques described herein provide a solution that can address identification, authorization, and authentication when only the PHY/MAC architecture of the NCR is applied. For instance, the NCR may only implement the PHY/MAC layer, in which case the repeater identification, authorization, authentication is performed based on communications exchanged over the PHY/MAC layer between the NCR and a network entity or node (e.g., a DU and/or CU of a base station and/or a CN).

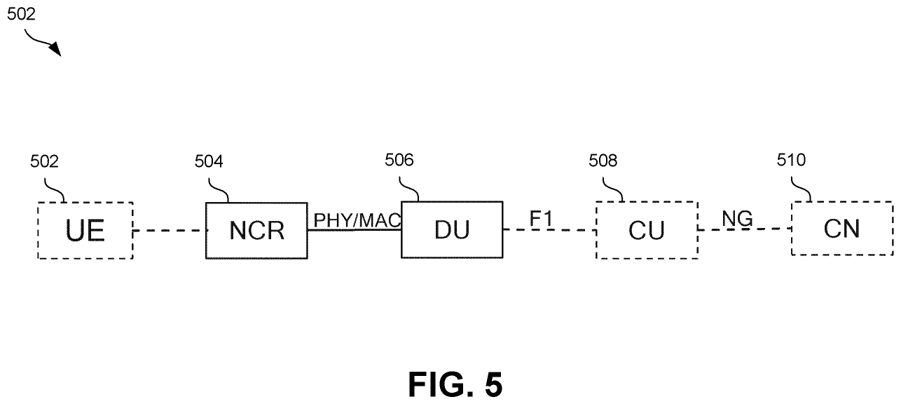

FIG. 5 illustrates a block diagram 500 including a user equipment (UE) 502 communicating with a network-controlled repeater (NCR) 504. The NCR 504 communicates with a distributed unit (DU) 506 of a base station (e.g., a gNodeB (gNB)) using a PHY/MAC protocol according to the PHY/MAC layers. The DU 506 communicates via an F1 interface with a centralized unit (CU) 508 of the base station (e.g., gNB), and the CU 508 communicates via a next generation (NG) interface with a core network (CN) 510. The NG application protocol may provide control plane signaling between various nodes, such as between the base station (e.g., the CU 508) and the CN 510. Other communication protocol interfaces or functions may be used in other examples, such as an E1 interface, an Xn interface, or other interface. In some examples, the DU 506 may correspond to the DU 330, the CU 508 may correspond to the CU 310, and the CN 510 may correspond to the core network 170.

In some cases, the CU 508 may support higher layers of the protocol stack, such as Service Data Adaption Protocol (SDAP), Packet Data Convergence Control (PDCP), and Radio Resource Control (RRC). In some cases, the DU 506 may support lower layers of the protocol stack, such as Radio Link Control (RLC), the MAC, and the PHY layer. In some examples, there may be a single CU for each base station (e.g., for each gNB). For instance, one CU 508 may control multiple DUs (e.g., including DU 506) In one illustrative example, the CU 508 may control more than 100 DUs that are connected (e.g., wired and/or wirelessly) to the CU 508.

In some aspects, according to the systems and techniques described herein, the NCR 504 is associated with or pre-configured with an identifier (referred to herein as an identifier associated with the NCR 504). In some cases, the identifier associated with the NCR 504 may include, for example, a manufacture assigned identifier (ID), an operator assigned ID, or other ID. In some examples, the identifier associated with the NCR 504 may be globally unique or unique on a country-wide basis. The NCR 504 can transmit a message (e.g., MSG1, MSGA, or other message as described herein) including at least the identifier of the NCR 504 to the DU 506, and the DU 506, CU 508, or CN 510 can perform identification and authorization of the NCR 504 for use as part of a multi-step Random Access Channel (RACH) process. For instance, the DU 506, CU 508, or CN 510 can include a database used for the identification and authorization.

In some aspects, the NCR 504 may generate an authenticator that can be used by the DU 506, CU 508, or CN 510 to authenticate the NCR 504. In some cases, the NCR 504 can generate the authenticator using, for example, a Hash-based message authentication code (HMAC) algorithm based on a pre-configured common key and optionally based on other input, such as keying material (e.g., a cell ID such as a Physical-layer Cell Identifier or Identity (PCI) and/or New Radio (NR) Cell Identifier or Identity (NCI), a preamble ID, and/or a RACH resource used). In one illustrative example, there may be, for example, 64 total preambles for each node. The UE 502 can generate one of the 64 preambles for the cell to which it wants to connect. The NCI of the cell can be concatenated with a public land mobile network (PLMN) identifier (PLMN-ID) to form an NCGI or NR Cell Global Identity. The HMAC is a cryptographic authentication technique that uses a hash function and a secret key. With HMAC, the system can achieve authentication and verify that data is correct and authentic with shared secrets, as opposed to approaches that use signatures and asymmetric cryptography.

As noted above, according to some aspects, the NCR 504 only implements the PHY/MAC layer. In such aspects, the identification, authorization, and in some cases authentication of the NCR 504 is performed by the DU 506, CU 508, or CN 510 based on the NCR 504 communicating with the DU 506 over the PHY/MAC layer. In cases where the CU 508 or CN 510 perform the identification, authorization, and in some cases authentication of the NCR 504, the DU 506 can send the relevant information (e.g., the identifier associated with the NCR 504, the authenticator, etc.) to the CU 508 and/or the CN 510. Using such techniques, identification, authorization, and/or authentication of the NCR 504 can be performed even when the NCR 504 utilizes a PHY/MAC only architecture.

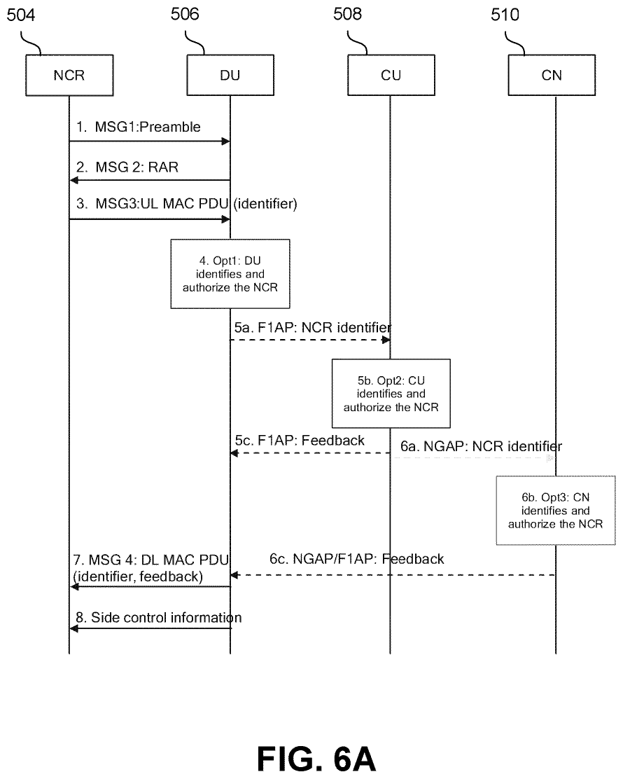

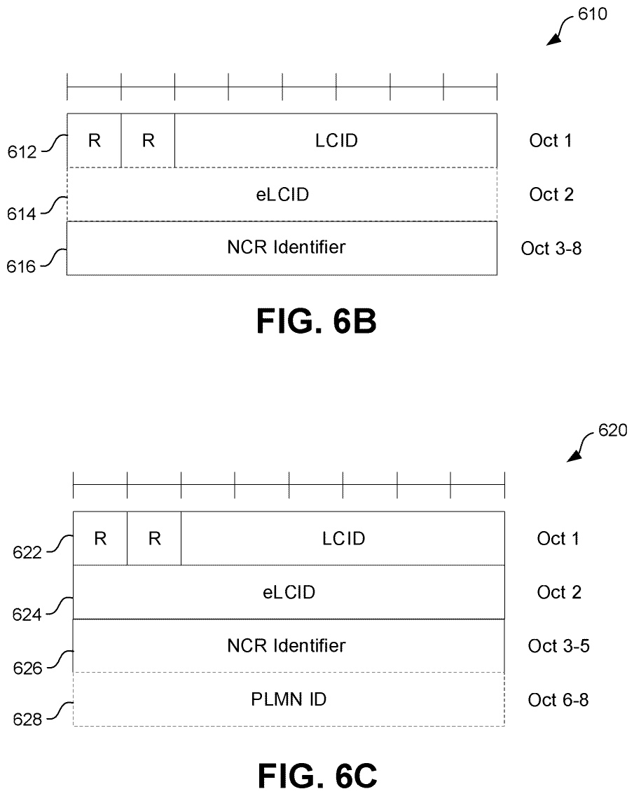

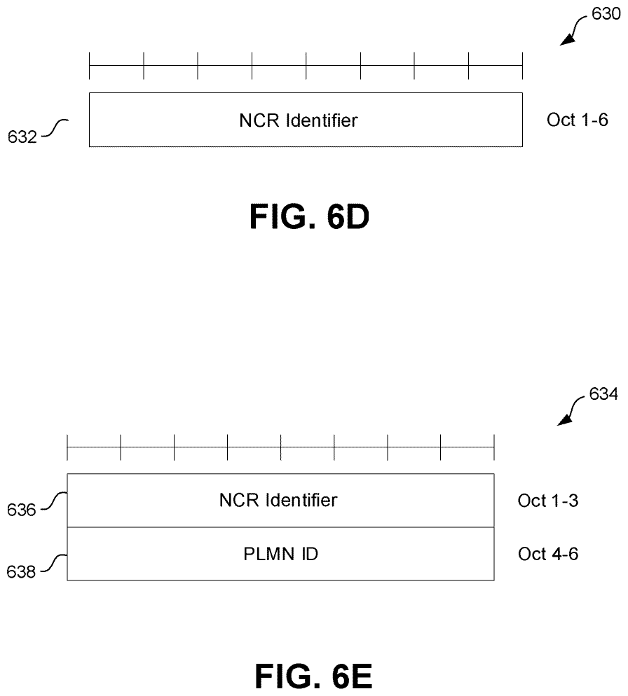

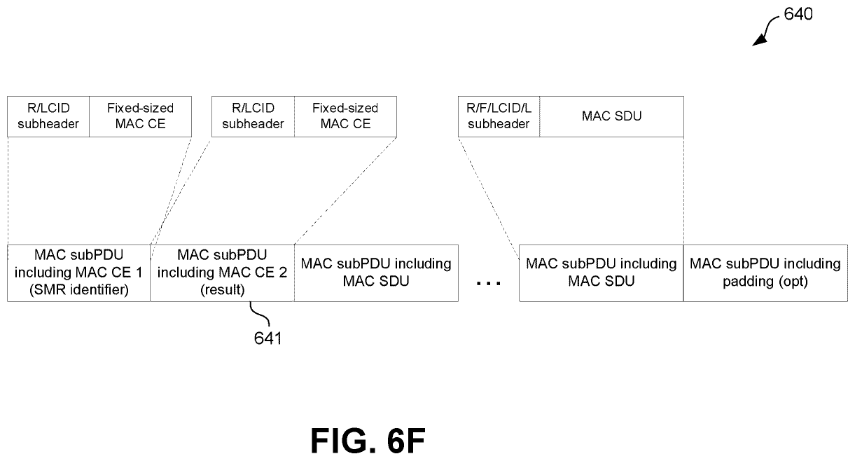

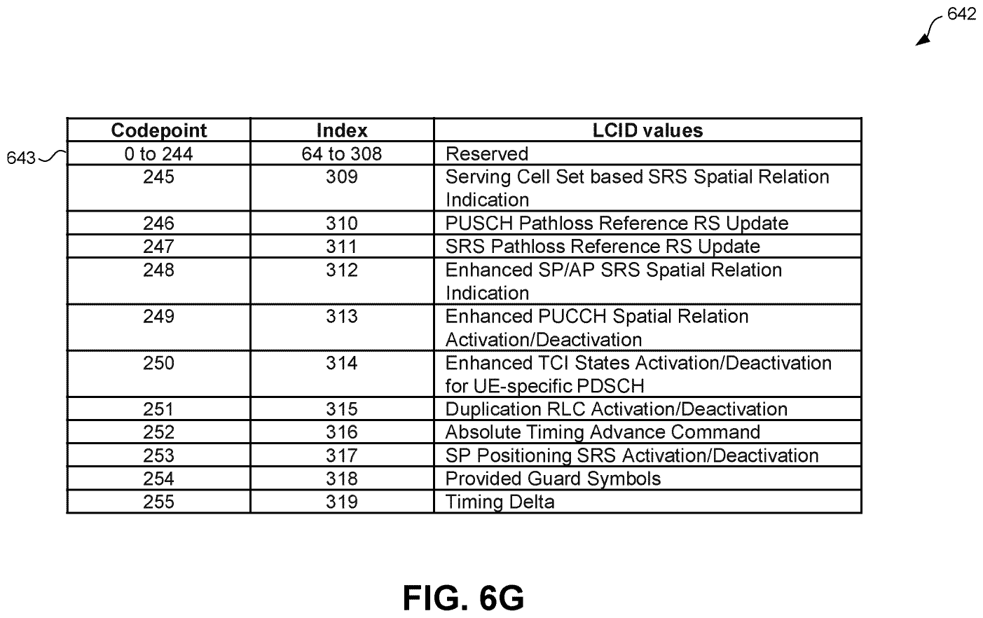

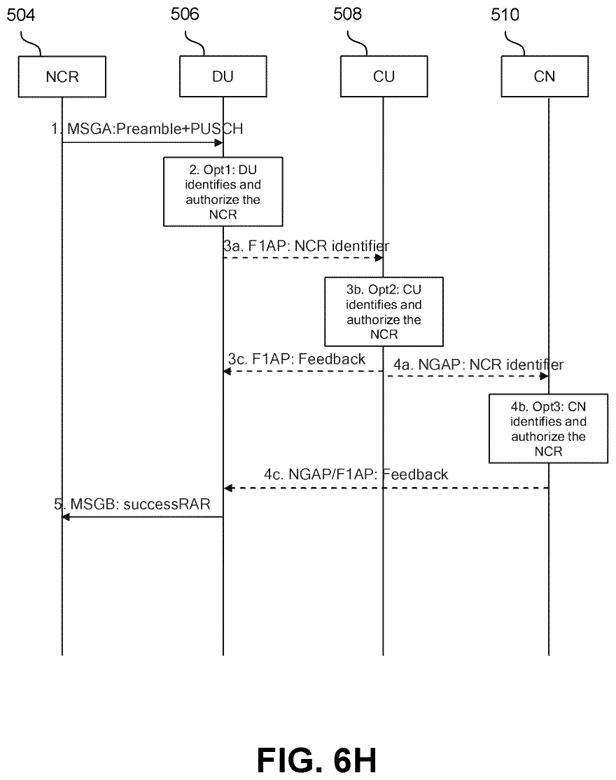

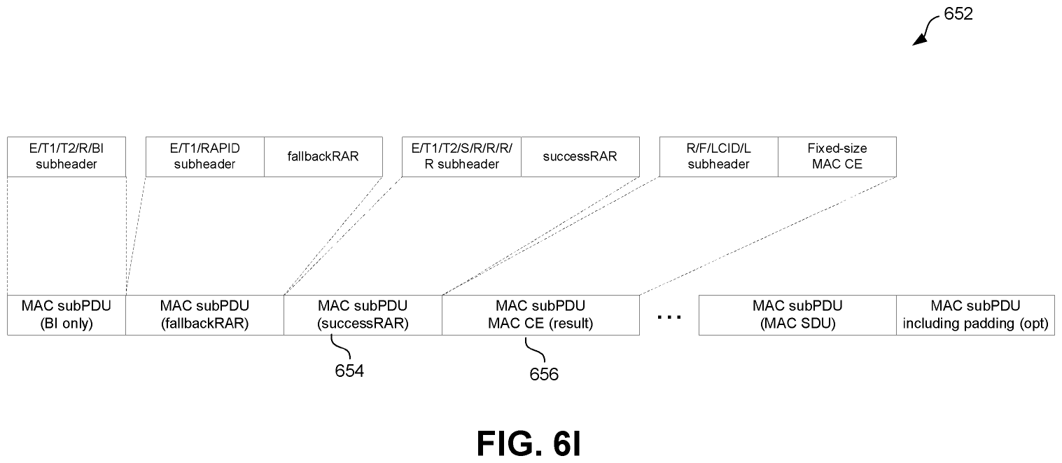

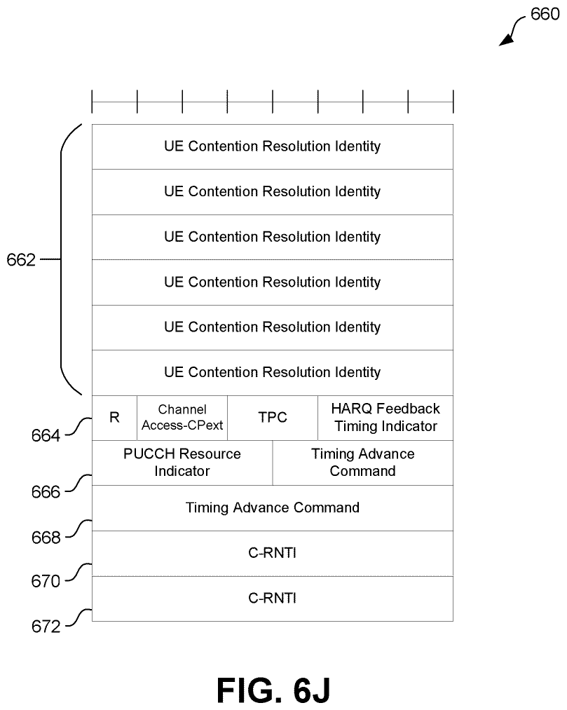

FIGS. 6A-6J are signaling diagrams illustrating examples of communications among the NCR 504, DU 506, CU 508, and CN 510 for performing identification and authorization (and in some cases authentication) of the NCR 504. For example, the signaling diagram of FIG. 6A shows four messages (MS1, MSG2, MSG3 and MSG4) that are exchanged between the NCR 504 and the DU 506 as part of a 4-step Random Access Channel (RACH) process. For example, at operation 1 illustrated in FIG. 6A, the NCR 504 transmits a message (referred to as MSG1) including a preamble (e.g., a contention-based or contention-free PRACH preamble). After detecting the preamble, at operation 2 illustrated in FIG. 6A, the DU 506 responds by transmitting a message (referred to as MSG2) including a random-access response (RAR). For instance, the RAR may include a preamble ID detected by the DU 506 in the MSG1, a timing advance (TA) command, a cell-Radio Network Temporary Identifier (C-RNTI or TC-RNTI), an uplink grant for scheduling a data transmission (e.g., Physical Uplink Shared Channel (PUSCH) transmission) from the NCR 504 (e.g., included in MSG3 described below), any combination thereof, and/or other information.

At operation 3 of FIG. 6A, the NCR 504 may then transmit a message (referred to as MSG3) in response to the RAR received in the MSG2. The MSG3 includes the identifier associated with the NCR 504 for the RACH process. The MSG3 may include a Medium Access Control (MAC) Control Element (CE) as part of a sub-Protocol Data Unit (subPDU), as described in more detail below with respect to FIGS. 6B-G. In some cases, no other upper layer service data unit (SDU) is included in the MSG3. In some cases, the MSG3 may also include a public land mobile network (PLMN) identifier (PLMN-ID). As noted above, identification and authorization of the NCR 504 can be performed by the DU 506, CU 508, or CN 510 based on the information (e.g., the identifier associated with the NCR 504 and the PLMN ID) included in the MSG3. For instance, operations 4, 5 and 6 of FIG. 6A illustrate different options for identification and authorization, which may be based on which network node (the DU 506, CU 508, or CN 510) includes the database used for the identification and authorization.

In the option shown in operation 4, upon receiving MSG3, the DU 506 may perform the identification and authorization of the NCR 504 based on the information (e.g., the identifier associated with the NCR 504 and the PLMN ID) included in the MSG3. In such an example, at operation 7 illustrated in FIG. 6A, the DU 506 can transmit a fourth message (referred to as MSG4, which can be a MAC PDU) including the identifier associated with the NCR 504 as a Contention Resolution Identity or Identifier or other RACH identity or identifier and, in some cases, including the PLMN ID that was included with the MSG3. In some aspects, the DU 506 may transmit authorization and/or identification results to the NCR 504, illustrated as “feedback” in FIG. 6A. In some cases, the DU 506 may transmit side control information at operation 8 of FIG. 6A.

In the option shown in operation 5a of FIG. 6A, upon receiving MSG3, the DU 506 may forward or transmit the information (e.g., the identifier associated with the NCR 504 and the PLMN ID) included in the MSG3 to the CU 508, and the CU 508 can perform the identification and authorization of the NCR 504 based on the information at operation 5b. In such an example, at operation 5c, the CU 508 can transmit authorization and/or identification results (illustrated as feedback in FIG. 6A) to the DU 506. The DU 506 can then transmit, at operation 7, MSG4 (e.g., a MAC PDU) including the identifier associated with the NCR 504 and in some cases the PLMN ID as a RACH identity or identifier (e.g., for contention resolution such as a Contention Resolution Identity, CFRA RACH, etc.). As noted above, the DU 506 may transmit the authorization and/or identification results to the NCR 504 (e.g., the “feedback” shown in FIG. 6A).

In the option shown in operation 6a, upon receiving the information (e.g., the identifier associated with the NCR 504 and the PLMN ID), the CU 508 may forward or transmit the information (e.g., the identifier associated with the NCR 504 and the PLMN ID) to the CN 510, and the CN 510 can perform the identification and authorization of the NCR 504 based on the information at operation 6b. In such an example, the CN 510 can transmit authorization and/or identification results (illustrated as “feedback” in FIG. 6A) to the DU 506 at operation 6c. At operation 7, the DU 506 can then transmit MSG4 (e.g., a MAC PDU) including the identifier associated with the NCR 504 and in some cases the PLMN ID as the RACH identity or identifier (e.g., for contention resolution such as a Contention Resolution Identity, CFRA RACH, etc.). As noted above, the DU 506 may transmit the authorization and/or identification results to the NCR 504 (e.g., the “feedback” shown in FIG. 6A).

In some aspects, a random access contention resolution timer (e.g., denoted as ra-ContentionResolutionTimer) may need to be extended, such as to account for the additional messaging/communications shown in FIG. 6A as compared to conventional a RACH process.

FIG. 6B illustrates an example of a data structure 610 that includes one alternative MAC subPDU format for a MAC CE that can be used in the 4-step RACH process of FIG. 6A. A MAC CE is a particular MAC structure that can carry control information. In some cases, the UE Contention Resolution Identity or Identifier (e.g., in MSG2, MSG3, or other message) can be limited to 48 bits. As shown in FIG. 6B, as a first alternative, the data structure 610 includes the identifier associated with the NCR 504 (to be used as a Contention Resolution Identity or Identifier, etc.) in a field 612 and does not include a PLMN for identification and authorization. In one illustrative example, the maximum size of the identifier associated with the NCR 504 can be 48 bits. As noted herein, the identifier associated with the NCR 504 can be assigned by manufacturer or operator and can be globally unique or country-wide unique. Other fields are also included in the data structure 610, including a field 612 with two reserved bits and a number of logical channel ID (LCID) bits, and a field 616 with extended-LCID (eLCID) bits. The fields are shown with different octet data structures.

FIG. 6C is another example of a data structure 620 including different fields 622, 624, 626, and 628. As shown, the data structure 620 includes a field 626 including the identifier associated with the NCR 504 and a field 628 including a PLMN ID. The data structure 620 can thus be used for PLMN identification and authorization. The identifier associated with the NCR 504 and the PLMN ID can be used as a Contention Resolution Identity or Identifier or as another identifier (e.g., for CFRA RACH). In one illustrative example, the PLMN ID can be 24 bits and the maximum size of the NCR identifier can be 24 bits. Other bit totals can be used in other examples. In some cases, identifier associated with the NCR 504 can be pre-configured by the PLMN. As shown in FIG. 6C, the data structure 620 further includes a field 622 with two reserved bits and a number of logical channel ID (LCID) bits, and a field 624 with extended-LCID (eLCID) bits. The fields are shown with different octet data structures.

In some cases, in either the data structure 610 or the data structure 620, if the NCR has no identifier or no need to identify/authorize each NCR, the NCR can generate a random value for the RACH process and/or for contention resolution, Contention-Free Random Access (CFRA) RACH, etc.

FIG. 6D illustrates a PDU 630 with a dedicated MAC format. The PDU 620 includes a field 632 with the identifier associated with the NCR 504 and does not include any PLMN information. For example, if a dedicated preamble is used for the NCR 504, then a dedicated MAC format can be used. In a dedicated MAC format, no LCID is included. The NCR 504 can generate a MAC PDU with the dedicated format on an uplink grant assigned for a dedicated preamble. This allows for a smaller size of the MSG3. In the example of FIG. 6D, the identifier of the NCR 504 size can be 48 bits in one illustrative example. FIG. 6E illustrates another example of a PDU 634 with a dedicated MAC format. The PDU 634 includes a field 636 with the identifier associated with the NCR 504 and a field 638 with a PLMN ID. In one illustrative example, the size of the identifier of the NCR 504 in field 636 can be 24 bits and the PLMN ID 638 in field 638 can be 24 bits. In some cases, if the NCR 504 has no identifier or there is no need to identify/authorize each NCR, then the NCR 504 can generate a random value for the RACH process and/or for contention resolution, Contention-Free Random Access (CFRA) RACH, etc. (e.g., when there is a need to identify/authorize the NCR 504, such as for contention resolution, CFRA RACH, etc.).

FIG. 6F illustrates an example data structure 640 for the MSG4 PDU that provides the feedback shown in FIG. 6A. The example data structure 640 of FIG. 6F uses a new MAC CE to provide a feedback result 641 at a particular location in the data structure 640. For example, the presence of an eLCID value 308 (e.g., see the entry 643 in the table 642 of FIG. 6G) can indicate to the NCR 504 an acknowledgement (ACK) as feedback. In another example, the absence of an LCID or eLCH value 308 can indicate a negative ACK (NACK) or no acknowledgment. The structure 640 can have a fixed size, such as zero bits. FIG. 6G illustrates a table 642 having a codepoint, an index, and an example of LCID values. As noted above, entry 643 of the table 642 illustrates an example of reserved LCID values that can indicate the feedback (e.g., a ACK or NACK) for the identification and/or authorization determined during the 4-step RACH process of FIG. 6A.

FIG. 6H illustrates an example of a 2-step RACH process. In operation 1 of FIG. 6H, the NCR 504 transmits a message (referred to as MSGA) to the DU 506. The MSGA may be or may include a MAC CE. As shown, the MSGA may include a preamble (e.g., similar to the preamble included in the MSG1 of 4-step RACH process of FIG. 6A) and additionally may include a physical uplink shared channel (PUSCH) carrying a MAC PDU including the identifier associated with the NCR 504 (and in some cases a PLMN ID as described above). Operations 2, 3a-c, and 4a-c of FIG. 6H are similar to operations 4, 5a-c, and 6a-c of the 4-step RACH process of FIG. 6A, where the DU 506 (at operation 2), the CU 508 (at operation 3b), or the CN 510 (at operation 4b) performs the identification and/or authorization of the NCR 504.

At operation 5 of FIG. 6H, the DU 506 may transmit a message (referred to as MSGB) including a success Random Access Response (successRAR) and the identifier associated with the NCR 504 (and in some cases including the PLMN ID, as described above with respect to FIG. 6A) as a Contention Resolution Identity or Identifier or other RACH identity or identifier (e.g., for CFRA RACH, etc.). In some cases, the MSGB can include the authorization and/or identification results as feedback from the DU 506 to the NCR 504. In the example of FIG. 6H, the MAC PDU carried in the PUSCH in operation 1 can be the same as any one of the examples described above with respect to FIGS. 6B-G.

The two-step RACH process shown in FIG. 6H may reduce latency and control signaling overhead by having a single round trip cycle between the NCR 504 and the base station (e.g., the DU 506 and the CU 508). This can be achieved by combining the preamble (MSG1 from FIG. 6A) and the scheduled PUSCH transmission (MSG3 from FIG. 6A) into a single message (MSGA) from the NCR 504. By combining the random-access response (MSG2 from FIG. 6A) and the RACH message (e.g., MSG4 from FIG. 6A) into a single message (MSGB) from the DU 506 (or other representative network entity) to the NCR 504.

FIG. 6I shows an example of a data structure 652 for the identification and/or authorization feedback included in the MSGB. The data structure 652 is provided in the context of a 2-step RACH process (e.g., as shown in FIG. 6H) in which the MSGB MAC PDU is used for the feedback. The example of FIG. 6I provides one illustrative example where a new MAC CE may be used to carry feedback for the identification and/or authorization. In one example, the new MAC CE may be a fixed-size MAC CE including a MAC subPDU MAC CE 658 with one or more bits indicating the result (e.g., an ACK or NACK) of the identification and/or authorization. The data structure 652 further includes the successRAR 654 that can be included in the MSGB.

In another example, a reserved (“R”) bit in the successRAR (e.g., a MAC subPDU of the successRAR) may be used for the identification and/or authorization feedback included in the MSGB. For example, FIG. 6J illustrates a table 660 having a series of UE Contention Resolution Identity data fields 662 in addition to other data fields 664, 666, 668, 670, 672. As shown, the data field 664 includes a reserved (R) bit that that can indicate a result (e.g., an ACK or NACK) of the identification and/or authorization.

Additionally or alternatively, in some aspects, the systems and techniques described herein may use a MAC CE-combination MSG3 MAC+MSG5 MAC (e.g., for de-prioritization). In such aspects, the NCR 504 may include the identifier associated with the NCR 504 in the MSG3 MAC CE (e.g., of FIG. 6A). For instance, the NCR 504 may provide a 1-bit indication in the MSG3 MAC CE. In some examples, the NCR 504 can use a random value for contention resolution, CFRA RACH, etc. The base station (e.g., the DU 506) may indicate in MSG4 (e.g., of FIG. 6A) to the NCR 504 whether to include the identifier of the NCR 504 and optionally whether to include the PLMN ID in the MSG5 MAC CE. In the event the MSG4 indicates to include the identifier and/or the PLMN ID, the NCR 504 indicates the identifier and optionally the PLM ID in the MSG5 MAC CE.

Additionally or alternatively, in some aspects, the systems and techniques may perform MAC CE-based authentication. For example, as previously described, the NCR 504 may generate an authenticator using, for example, an HMAC algorithm based on a pre-configured common key. The NCR 504 may send the authenticator in a MAC CE to the DU 506. The DU 506 may authenticate the NCR 504 based on a common key using an algorithm such as the HMAC algorithm. If the authentication is performed in the CU 508 or the CN 510, then the DU 506 may forward the authenticator to the CU 508 or the CN 510. In some cases, the authentication procedure can be performed after the identification and/or authorization procedure is completed successfully.

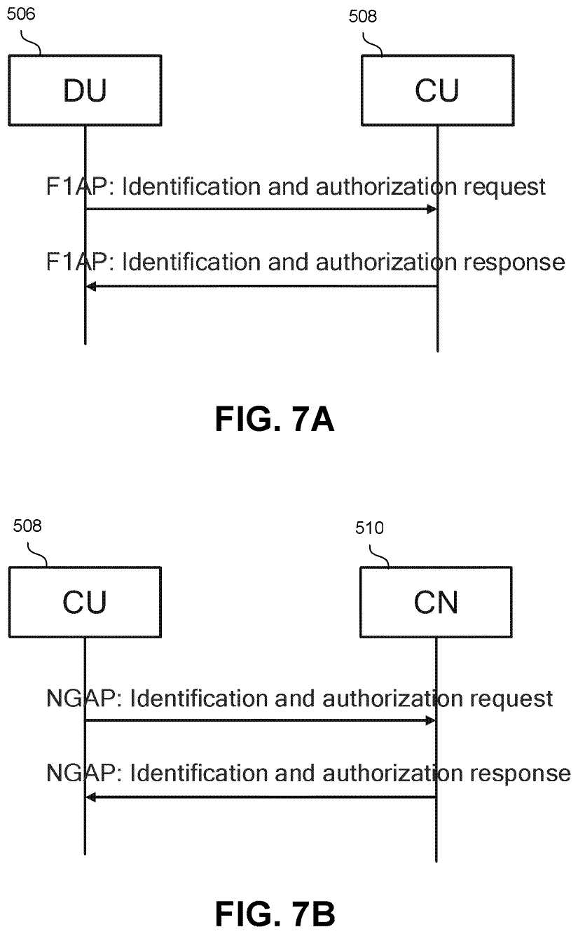

FIG. 7A is a signaling diagram illustrating an example of communications between the DU 506 and the CU 508 using an F1 interface. The example of FIG. 7A introduces an F1 interface procedure that is CU-based, and provides a new next generation application protocol (NGAP) procedure in which identification, authorization, and/or authentication requests/responses are communicated using the F1 interface (e.g., an F1 application protocol (F1AP) interface). For example, the DU 506 can transmit an NCR type of device and an NCR identifier and/or authenticator for the NCR 504 to the CU 508 over the F1 interface. The CU 508 may then identify, authorize, and/or authenticate the NCR 504 and provide a response to the DU 506 over the F1 interface.

FIG. 7B is a signaling diagram illustrating an example of communications between the CU 508 and the CN 510 using a next generation (NG) interface. The example of FIG. 7B introduces an NG interface procedure that is CN-based, and provides a new NGAP procedure in which the identification, authorization, and/or authentication request/response are communicated using the NG interface (e.g., an NG application protocol interface). For example, the DU 506 can transmit an NCR type of device and an NCR identifier and/or authenticator for the NCR 504 to the CN 510 over the NG interface. The CN 510 may then identify, authorize, or authenticate the NCR 504 and provide a response to the CU 508 over the NG interface.

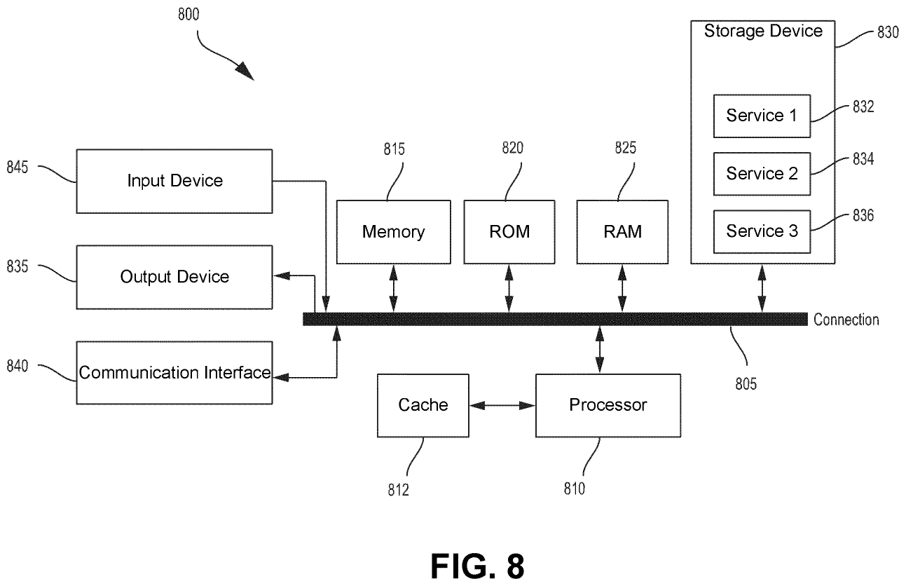

In some examples, the processes described herein may be performed by a computing device or apparatus (e.g., the NCR 504, a network entity such as the DU 506, CU 508, and/or CN 510, the UE 502, etc.). In another example, the processes may be performed by a computing device with the computing system 800 shown in FIG. 8. For instance, a wireless communication device (e.g., the NCR 504 of FIG. 5, the UE 502 of FIG. 5, and/or other device) with the computing architecture shown in FIG. 8 may include the components of the UE and may implement the operations of any of the processes described herein.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The processes may be described herein as logical flow diagrams, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 812 of high-speed memory connected directly with, in close proximity to, or integrated as part of processor 810.

Processor 810 may include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM). FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor: but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the present disclosure include:

Aspect 1. A method for wireless communications at a network-controlled repeater, the method comprising: transmitting, from the network-controlled repeater, a first message to a network entity, the first message including an identifier associated with the network-controlled repeater for use as part of a multi-step Random Access Channel (RACH) process; and receiving, from the network entity, a second message at least one of identifying or authorizing the network-controlled repeater for the RACH process.

Aspect 2. The method of Aspect 1, further comprising communicating with the network entity using at least one of a Physical (PHY) layer or a Medium Access Control (MAC) layer.

Aspect 3. The method of any of Aspects 1 or 2, further comprising communicating with the network entity using only at least one of a Physical (PHY) layer or a Medium Access Control (MAC) layer.

Aspect 4. The method of any of Aspects 1 to 3, wherein the network entity comprises a base station.

Aspect 5. The method of any of Aspects 1 to 4, wherein the network entity comprises one of a centralized unit (CU), a distributed unit (DU), or a core network (CN) of a base station.

Aspect 6. The method of any of Aspects 1 to 5, wherein the first message comprises a Medium Access Control (MAC) Control Element (CE).

Aspect 7. The method of Aspect 6, wherein the first message comprises no other upper layer service data unit.

Aspect 8. The method of any of Aspects 6 or 7, wherein the MAC CE of the first message is included in a MAC sub-Protocol Data Unit (subPDU) comprising a field with the identifier associated with the network-controlled repeater and a Logical Channel Identification (LCID) field.

Aspect 9. The method of any of Aspects 6 or 7, wherein the MAC CE of the first message is included in a sub-MAC Protocol Data Unit (subPDU) comprising a field with the identifier associated with the network-controlled repeater, a field with a public land mobile network (PLMN) identification, and a Logical Channel Identification (LCID) field.

Aspect 10. The method of any of Aspects 6 to 9, wherein the MAC CE of the first message is included in a dedicated preamble of a MAC sub-Protocol Data Unit (subPDU) comprising a field with the identifier associated with the network-controlled repeater.

Aspect 11. The method of any of Aspects 6 to 9, wherein the MAC CE of the first message is included in a dedicated preamble of a MAC sub-Protocol Data Unit (subPDU) comprising a field with the identifier associated with the network-controlled repeater and a field with a public land mobile network (PLMN) identification.

Aspect 12. The method of any of Aspects 1 to 11, wherein the second message comprises the identifier associated with the network-controlled repeater and an identification and authorization feedback result for the network-controlled repeater as part of the multi-step RACH process.

Aspect 13. The method of Aspect 12, wherein the identification and authorization feedback is included in a Medium Access Control (MAC) Control Element (CE).

Aspect 14. The method of any of Aspects 12 or 13, wherein the identification and authorization feedback includes one of a presence of a value in a Logical Channel Identification (LCID) field of the MAC CE indicating an acknowledgement (ACK) or an absence of the value in the LCID field of the MAC CE indicating a negative acknowledgement (NACK).

Aspect 15. The method of any of Aspects 1 to 14, wherein the first message further comprises a public land mobile network (PLMN) identification.

Aspect 16. The method of Aspect 15, wherein the second message comprises the identifier associated with the network-controlled repeater, the PLMN identification, and an identification and authorization feedback result for the network-controlled repeater as part of the multi-step RACH process.

Aspect 17. The method of any of Aspects 1 to 16, further comprising transmitting an authenticator to the network entity for authentication of the network-controlled repeater.

Aspect 18. The method of Aspect 17, further comprising generating the authenticator using a hash-based message authentication code algorithm based on at least one of the identifier associated with the network-controlled repeater, a cell identifier, a preamble identifier, or a Random Access Channel (RACH) resource used by the network-controlled repeater.

Aspect 19. The method of any of Aspects 17 or 18, wherein the authenticator is transmitted in a Medium Access Control (MAC) Control Element (CE).

Aspect 20. The method of any of Aspects 1 to 19, wherein the network entity comprises a database used for at least one of identifying or authorizing the network-controlled repeater for the RACH process.

Aspect 21. The method of any of Aspects 1 to 20, wherein the multi-step RACH process includes a 4-step RACH process.

Aspect 22. The method of any of Aspects 1 to 21, wherein the multi-step RACH process includes a 2-step RACH process.

Aspect 23. The method of Aspect 22, wherein the first message comprises the identifier associated with the network-controlled repeater as part of a physical uplink shared channel (PUSCH) and a preamble.

Aspect 24. The method of any of Aspects 22 or 23, wherein the second message comprises a success random-access response (successRAR) message.

Aspect 25. The method of Aspect 24, wherein the successRAR message comprises the identifier associated with the network-controlled repeater.

Aspect 26. The method of any of Aspects 24 or 25, wherein a reserved bit is used for the successRAR message in a Medium Access Control (MAC) sub-Protocol Data Unit (subPDU).

Aspect 27. A method of wireless communication at a network-controlled repeater, the method comprising: transmitting, from the network-controlled repeater, an authenticator to a network entity via a Medium Access Control (MAC) Control Element (CE) for performing authentication of the network-controlled repeater; and receiving, at the network-controlled repeater, an authentication result from the network entity.

Aspect 28. The method of Aspect 27, wherein the authenticator is generated using a hash-based message authentication code algorithm based on a preconfigured common key.

Aspect 29. The method of Aspect 28, wherein the preconfigured common key is based on at least one of an identifier associated with the network-controlled repeater, a cell identifier, a preamble identifier, or a Random Access Channel (RACH) resource used by the network-controlled repeater.

Aspect 30. The method of any of Aspects 27 to 29, wherein the network entity comprises a distributed unit (DU) of a base station, a centralized unit (CU) of the base station, or a core network (CN).

Aspect 31. The method of Aspect 30, wherein the authentication of the network-controlled repeater is performed by the DU.

Aspect 32. The method of any of Aspects 30 or 31, wherein the authenticator is transmitted from the DU to the CU for performing the authentication of the network-controlled repeater, wherein the authentication result is transmitted from the CU to the DU, and wherein the authentication result is received from the DU.

Aspect 33. The method of any of Aspects 30 or 31, wherein the authenticator is forwarded from the DU to the CU with a request to perform authentication of the network-controlled repeater, and wherein the authenticator and the request are forwarded to the CN for performing authentication of the network-controlled repeater.

Aspect 34. The method of Aspect 33, wherein the authentication result is transmitted from the CN to the CU and is transmitted from the CU to the DU, and wherein the authentication result is received from the DU.

Aspect 35. A method of wireless communication at a first network entity, the method comprising: transmitting, from the first network entity to a second network entity, a message including at least one of a request for identification and authorization of a network-controlled repeater or a request for authentication of the network-controlled repeater; and receiving, at the first network entity from the second network entity, a response message associated with at least one of the request for identification and authorization of the network-controlled repeater or the request for authentication of the network-controlled repeater.

Aspect 36. The method of Aspect 35, wherein the first network entity comprises a distributed unit (DU) of a base station and wherein the second network entity comprises a centralized unit (CU) of the base station.

Aspect 37. The method of Aspect 36, wherein the message is transmitted from the DU to the CU over an F1 interface, and wherein the response message is received at the DU from the CU over the F1 interface.

Aspect 38. The method of any of Aspects 35 to 37, wherein the first network entity comprises a centralized unit (CU) of the base station and wherein the second network entity comprises a core network (CN).

Aspect 39. The method of Aspect 38, wherein the message is transmitted from the CU to the CN over a next generation (NG) interface, and wherein the response message is received at the CU from the CN over the NG interface.

Aspect 40. The method of any of Aspects 35 to 39, wherein the message further comprises a device type of the network-controlled repeater.

Aspect 41. The method of any of Aspects 35 to 40, wherein the response message includes an acknowledgement (ACK) indicating at least one of identification and authorization of the network-controlled repeater or authentication of the network-controlled repeater.

Aspect 42. The method of any of Aspects 35 to 40, wherein the response message includes a negative acknowledgement (NACK) indicating at least one of a failure of identification and authorization of the network-controlled repeater or a failure of authentication of the network-controlled repeater.

Aspect 43. An apparatus for wireless communications, comprising at least one memory and at least one processor coupled to at least one memory and configured to perform operations according to any of Aspects 1 to 26.

Aspect 44. The apparatus of Aspect 43, wherein the apparatus is configured as a network-controlled repeater, and further comprising: at least one transceiver configured to transmit the first message and receive the second message.

Aspect 45. A non-transitory computer-readable medium having stored thereon instructions that, when executed by one or more processors, cause the one or more processors to perform operations according to any of Aspects 1 to 26.

Aspect 46. An apparatus for wireless communications comprising one or more means for performing operations according to any of Aspects 1 to 26.

Aspect 47. An apparatus for wireless communications, comprising at least one memory and at least one processor coupled to at least one memory and configured to perform operations according to any of Aspects 27 to 34.

Aspect 48. The apparatus of Aspect 47, wherein the apparatus is configured as a network-controlled repeater, and further comprising: at least one transceiver configured to transmit the authenticator and receive the authentication result.

Aspect 49. A non-transitory computer-readable medium having stored thereon instructions that, when executed by one or more processors, cause the one or more processors to perform operations according to any of Aspects 27 to 34.

Aspect 50. An apparatus for wireless communications comprising one or more means for performing operations according to any of Aspects 27 to 34.

Aspect 51. An apparatus for wireless communications, comprising at least one memory and at least one processor coupled to at least one memory and configured to perform operations according to any of Aspects 35 to 42.

Aspect 52. The apparatus of Aspect 51, wherein the apparatus is configured as a first network entity, and further comprising: at least one transceiver configured to transmit the message to the second network entity and receive the response message.

Aspect 53. A non-transitory computer-readable medium having stored thereon instructions that, when executed by one or more processors, cause the one or more processors to perform operations according to any of Aspects 35 to 42.

Aspect 54. An apparatus for wireless communications comprising one or more means for performing operations according to any of Aspects 35 to 42.

Aspect 55. A method for wireless communications at a network entity, the method comprising: receiving, from a network-controlled repeater, a first message, the first message including an identifier associated with the network-controlled repeater for use as part of a multi-step Random Access Channel (RACH) process; and transmitting, to the network-controlled repeater, a second message at least one of identifying or authorizing the network-controlled repeater for the RACH process.

Aspect 56. An apparatus for wireless communications, comprising: at least one memory; and at least one processor coupled to at least one memory and configured to: receive, from a network-controlled repeater, a first message, the first message including an identifier associated with the network-controlled repeater for use as part of a multi-step Random Access Channel (RACH) process; and transmit, to the network-controlled repeater, a second message at least one of identifying or authorizing the network-controlled repeater for the RACH process.

Aspect 57. The apparatus of Aspect 56, wherein the apparatus is configured as a network entity, and further comprising: at least one transceiver configured to receive the first message and transmit the second message.

Aspect 58. A non-transitory computer-readable medium having stored thereon instructions that, when executed by one or more processors, cause the one or more processors to perform operations according to Aspect 56.

Aspect 59. An apparatus for wireless communications comprising one or more means for performing operations according to Aspect 56.

Aspect 60. A method of wireless communication at a network entity, the method comprising: receiving, from a network-controlled repeater, an authenticator via a Medium Access Control (MAC) Control Element (CE) for performing authentication of the network-controlled repeater; and transmitting an authentication result to the network-controlled repeater.

Aspect 61. An apparatus for wireless communications, comprising: at least one memory; and at least one processor coupled to at least one memory and configured to: receive, from a network-controlled repeater, an authenticator via a Medium Access Control (MAC) Control Element (CE) for performing authentication of the network-controlled repeater; and transmit an authentication result to the network-controlled repeater.

Aspect 62. The apparatus of Aspect 61, wherein the apparatus is configured as a network entity, and further comprising: at least one transceiver configured to receive the authenticator and transmit the authentication result.

Aspect 63. A non-transitory computer-readable medium having stored thereon instructions that, when executed by one or more processors, cause the one or more processors to perform operations according to Aspect 61.

Aspect 64. An apparatus for wireless communications comprising one or more means for performing operations according to Aspect 61.

1-60. (canceled)

61. An apparatus for wireless communications, comprising:
at least one memory; and
at least one processor coupled to at least one memory and configured to:
transmit a first message to a network entity, the first message including an identifier associated with the apparatus for use as part of a multi-step Random Access Channel (RACH) process; and
receiving, from the network entity, a second message at least one of identifying or authorizing the apparatus for the RACH process.

62. The apparatus of claim 61, wherein the at least one processor is configured to communicate with the network entity using at least one of a Physical (PHY) layer or a Medium Access Control (MAC) layer.

63. The apparatus of claim 61, wherein the at least one processor is configured to communicate with the network entity using only at least one of a Physical (PHY) layer or a Medium Access Control (MAC) layer.

64. The apparatus of claim 61, wherein the network entity comprises a base station or one of a centralized unit (CU), a distributed unit (DU), or a core network (CN) of the base station.

65. The apparatus of claim 61, wherein the apparatus comprises a network-controlled repeater.

66. The apparatus of claim 61, wherein the first message comprises a Medium Access Control (MAC) Control Element (CE).

67. The apparatus of claim 66, wherein the MAC CE of the first message is included in a MAC sub-Protocol Data Unit (subPDU) comprising a field with the identifier associated with the apparatus and a Logical Channel Identification (LCID) field.

68. The apparatus of claim 66, wherein the MAC CE of the first message is included in a sub-MAC Protocol Data Unit (subPDU) comprising a field with the identifier associated with the apparatus, a field with a public land mobile network (PLMN) identification, and a Logical Channel Identification (LCID) field.

69. The apparatus of claim 66, wherein the MAC CE of the first message is included in a dedicated preamble of a MAC sub-Protocol Data Unit (subPDU) comprising a field with the identifier associated with the apparatus.

70. The apparatus of claim 66, wherein the MAC CE of the first message is included in a dedicated preamble of a MAC sub-Protocol Data Unit (subPDU) comprising a field with the identifier associated with the apparatus and a field with a public land mobile network (PLMN) identification.

71. The apparatus of claim 61, wherein the second message comprises the identifier associated with the apparatus and an identification and authorization feedback result for the apparatus as part of the multi-step RACH process.

72. The apparatus of claim 71, wherein the identification and authorization feedback is included in a Medium Access Control (MAC) Control Element (CE).

73. The apparatus of claim 72, wherein the identification and authorization feedback includes one of a presence of a value in a Logical Channel Identification (LCID) field of the MAC CE indicating an acknowledgement (ACK) or an absence of the value in the LCID field of the MAC CE indicating a negative acknowledgement (NACK).

74. The apparatus of claim 61, wherein the first message further comprises a public land mobile network (PLMN) identification.

75. The apparatus of claim 74, wherein the second message comprises the identifier associated with the apparatus, the PLMN identification, and a identification and authorization feedback result for the apparatus as part of the multi-step RACH process.

76. The apparatus of claim 61, wherein the at least one processor is configured to transmit an authenticator to the network entity for authentication of the apparatus.

77. The apparatus of claim 76, wherein the at least one processor is configured to generate the authenticator using a hash-based message authentication code algorithm based on at least one of the identifier associated with the apparatus, a cell identifier, a preamble identifier, or a Random Access Channel (RACH) resource used by the apparatus.

78. The apparatus of claim 76, wherein the authenticator is transmitted in a Medium Access Control (MAC) Control Element (CE).

79. The apparatus of claim 61, wherein the first message comprises the identifier associated with the apparatus as part of a physical uplink shared channel (PUSCH) and a preamble.

80. The apparatus of claim 61, wherein the second message comprises a success random-access response (successRAR) message.

81. The apparatus of claim 80, wherein the successRAR message comprises the identifier associated with the apparatus.

82. The apparatus of claim 80, wherein a reserved bit is used for the successRAR message in a Medium Access Control (MAC) sub-Protocol Data Unit (subPDU).

83. An apparatus for wireless communications, comprising:
at least one memory; and
at least one processor coupled to at least one memory and configured to:
transmit an authenticator to a network entity via a Medium Access Control (MAC) Control Element (CE) for performing authentication of the apparatus; and
receive an authentication result from the network entity.

84. The apparatus of claim 83, wherein the authenticator is generated using a hash-based message authentication code algorithm based on a preconfigured common key.

85. The apparatus of claim 84, wherein the preconfigured common key is based on at least one of an identifier associated with the apparatus, a cell identifier, a preamble identifier, or a Random Access Channel (RACH) resource used by the apparatus.

86. The apparatus of claim 83, wherein the network entity comprises a distributed unit (DU) of a base station, a centralized unit (CU) of the base station, or a core network (CN).

87. The apparatus of claim 86, wherein the authentication of the apparatus is performed by the DU.

88. The apparatus of claim 86, wherein the authenticator is transmitted from the DU to the CU for performing the authentication of the apparatus, wherein the authentication result is transmitted from the CU to the DU, and wherein the authentication result is received from the DU.

89. The apparatus of claim 86, wherein the authenticator is forwarded from the DU to the CU with a request to perform authentication of the apparatus, and wherein the authenticator and the request are forwarded to the CN for performing authentication of the apparatus.

90. The apparatus of claim 89, wherein the authentication result is transmitted from the CN to the CU and is transmitted from the CU to the DU, and wherein the authentication result is received from the DU.
